(19) United States
(12) Patent Application Publication
(10) Pub. No.: US 2026/0352617 A1
(43) Pub. Date: Nov. 5, 2026

(54) INFORMATION PROCESSING METHOD AND DEVICE AND ELECTRONIC DEVICE

(71) Applicant: Lenovo (Beijing) Limited, Beijing (CN)

(72) Inventors: Shu GAO, Beijing (CN); Liang ZHANG, Beijing (CN)

(21) Appl. No.: 19/654,933

(22) Filed: Apr. 22, 2026

(30) Foreign Application Priority Data
Apr. 30, 2025 (CN) 202510572070.2

(51) Int. Cl. H04L 51/04; G06F 40/30; H04L 51/02

(52) U.S. Cl. CPC H04L 51/04; G06F 40/30; H04L 51/02

(57) ABSTRACT

An information processing method includes obtaining interaction data based on a conversation with a second device, the interaction data including first data transmitted from the second device to a first device, and second data being obtained based on an input component of the first device; analyzing content of the interaction data; and in response to the content of the interaction data meeting an output condition, outputting third data to the second device, the third data being data generated by a target model based on content of the first data.

### CROSS-REFERENCES TO RELATED APPLICATION

This application claims priority to Chinese Patent Application No. 202510572070.2 filed on Apr. 30, 2025, the entire content of which is incorporated herein by reference.

### FIELD OF TECHNOLOGY

The present disclosure relates to the field of communications and, more specifically, to an information processing method and device, and an electronic device.

### BACKGROUND

When using electronic devices for communication, whether via audio or text, the process of querying, retrieving, and outputting relevant information generally requires a series of cumbersome steps, resulting in poor user experience.

### SUMMARY

One aspect of this disclosure provides an information processing method. The information processing method includes obtaining interaction data based on a conversation with a second device, the interaction data including first data transmitted from the second device to a first device, and second data being obtained based on an input component of the first device; analyzing content of the interaction data; and in response to the content of the interaction data meeting an output condition, outputting third data to the second device. The third data is data generated by a target model based on content of the first data.

Another aspect of this disclosure provides an information processing device. The information processing device includes a first module, a second module, and a third module. The first module is configured to obtain interaction data based on a conversation with a second device. The interaction data includes first data transmitted from the second device to a first device, and second data being obtained based on an input component of the first device. The second module is configured to analyze content of the interaction data. The third module is configured to, in response to the content of the interaction data meeting an output condition, output third data to the second device. The third data is data generated by a target model based on content of the first data.

Another aspect of this disclosure provides an electronic device. The electronic device includes one of more communication units, one or more memories, and one or more processors. The one of more communication units are configured to conduct a conversation with a second device. The one or more memories store computer instructions and a target model. The one or more processors are configured to load the computer instructions to analyze content of interaction data, transmit third data to the second device in response to the content of the interaction data meeting an output condition, and load the target model to generate the third data based on content of first data.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a flowchart of an information processing method according to some embodiments of the present disclosure.

FIG. 2 is a flowchart of the information processing method according to some embodiments of the present disclosure.

FIG. 3 is a schematic diagram of a communication interface on a first device when a first user and a second user are engaged in a conversation via text messages according to some embodiments of the present disclosure.

FIG. 4 is a flowchart of the information processing method according to some embodiments of the present disclosure.

FIG. 5 is a flowchart of the information processing method according to some embodiments of the present disclosure.

FIG. 6 is a schematic diagram of an information processing device according to some embodiments of the present disclosure.

FIG. 7 is a schematic structural diagram of an electronic device according to some embodiments of the present disclosure.

### DETAILED DESCRIPTION

Embodiments of the present disclosure are described below in conjunction with the accompanying drawings of embodiments of the present disclosure. The terms used in embodiments of the present disclosure are only used to explain specific embodiments of the present disclosure, and are not intended to limit the present disclosure.

The following describes the embodiments of the present disclosure with reference to the accompanying drawings. The terms used in the embodiments of the present disclosure are only used to explain the specific embodiments of the present disclosure, and are not intended to limit the present disclosure. One of ordinary skilled in the art may learn that, with technological development and emergence of a new scenario, the technical solutions provided in embodiments of the present disclosure are also applicable to a similar technical problem.

In this specification, claims, and accompanying drawings of the present disclosure, the terms “first”, “second”, and the like are intended to distinguish between similar objects but do not necessarily indicate a specific order or sequence. It should be understood that the terms used in such a way are interchangeable in proper circumstances, and this is merely a discrimination manner for describing objects having a same attribute in embodiments of the present disclosure. In addition, the terms “include”, “contain” and any other variants mean to cover the non-exclusive inclusion such that a process, method, system, product, or device that includes a series of units is not necessarily limited to those units, but may include other units not expressly listed or inherent to such a process, method, system, product, or device.

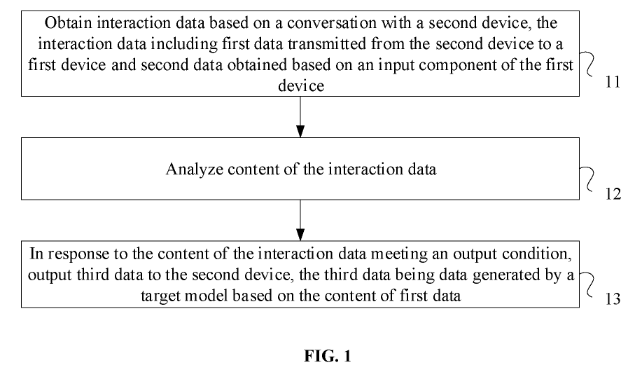

FIG. 1 is a flowchart of an information processing method according to some embodiments of the present disclosure. The method will be described in detail below.

11, obtaining interaction data based on a conversation with a second device, the interaction data including first data transmitted from the second device to a first device and second data being obtained based on an input component of the first device.

12, analyzing the content of the interaction data.

13, in response to the content of the interaction data meeting an output condition, outputting third data to the second device, the third data being data generated by a target model based on the content of first data.

When using electronic devices for communication, whether via audio or text, the process of querying, retrieving, and outputting relevant information generally requires a series of cumbersome steps, resulting in poor user experience.

Based on this, in the technical solutions provided in the embodiments of the present disclosure, when a first device and a second device engage in a conversation, the interaction data generated during the conversation is obtained and analyzed to generate third data. When the third data meet an output condition, the third data can be output to the second device. In this way, the relevant data is generated based on the interaction data produced during the conversation, which is subsequently output to the second device. This process automatically generates and outputs the relevant data without requiring any user intervention, thereby simplifying operations and enhancing the user experience.

The conversation between the first device and the second device may take the form of an audio-based conversation, such as a voice call, or a text-based conversation, such as text-based chatting.

During the conversation between the first device and the second device, the first device transmits second data to the second device, and the second device transmits first data to the first device. The first data and the second data can be designated as the interaction data, that is, the interaction data includes the first data and the second data. In the case of an audio-based conversation, the interaction data may be the voices of the two communicating parties; in the case of a text-based session, the interaction data may be their chat text.

The information processing method disclosed of the present disclosure can be applied to the first device or the second device. However, in this embodiment, the information processing method is described as being applied to the first device. The first device may include an intelligent program or system, through which the information processing method provided in the embodiments of the present disclosure can be implemented. Specifically, during the conversation between the first device and the second device, the intelligent program or system can monitor the conversation. once it determines that the output conditions have been met, it actively outputs third data to the second device. When it is determined that the output condition is met, the third data can be actively output to the second device. This ensures the timely retrieval of third data while eliminating the need for manual user intervention, thereby enhancing the user experience.

The intelligent program described in the embodiments of the present disclosure may be an application of artificial intelligence technology, that is, an agent. The agent possesses the capability to direct the operation of the target model, including but not limited to, invoking the target model to perform relevant tasks. Alternatively, the intelligent program itself may include a target model. When an intelligent program is running, it executes its target model, and the behavior of the intelligent program may be determined by the target model of the intelligent program based on the current state and external inputs. Through extensive data learning and training, the target model can provide a foundation for decision-making, and the agent can leverage tools, plugins, and knowledge bases to deliver capabilities in reasoning, decision-making, and execution.

During the conversation between the first device and the second device, the first device may obtain first data transmitted from the second device to the first device, and may also obtain second data. The second data may be obtained directly based on the input component of the first device. That is, when a user of the first device transmits the second data to the second device, the user first inputs the second data into the first device via the first device's input component, then the first device transmits the second data to the second device over a network. When a user inputs second data into the first device via the input component of the first device, the first device obtains the second data.

After receiving the interaction data, the first device analyzes the content of interaction data to determine whether it meets the output condition. Whether the content of the interaction data meets the output condition determines whether the first device needs to output the third data to the second device. If, based on the content of the interaction data, it is determined that the output condition is met, the first device will output the third data to the second device; if, based on the content of the interaction data, it is determined that the output condition is not met, the first device will not output the third data to the second device.

The third data may include data generated by the first device based on the content of the first data using the target model. The third data may be generated and output upon the determination that the output condition has been met. Alternatively, after obtaining the content of the interaction data, the third data may be generated by the target model based on the content of the first data, and output when the content of the interaction data meets the output condition.

Take the query process as an example. The third data may be generated based on raw data (e.g., the retrieved order numbers, phone numbers, etc.) obtained after executing the queries using the target model. Alternatively, the third data may be generated by processing the result obtained after the target model executes the query, for example, text or audio output generated by refining the obtained order numbers, phone numbers, and similar details to align with the current conversational style. For query-based tasks, when generating the third data, the target model may retrieve data relevant to the content of the first data by querying locally from the first device or searching for it in the cloud.

Since the first data consists of data transmitted from the second device to the first device, and the second data is obtained from an input component of the first device, that is, the second data is the data to be transmitted to the second device. When the first data transmitted from the second device to the first device includes at least data corresponding to specific information that needs to be obtained, it can be determined that the content of the interaction data meets the output condition. At this time, a query is performed using the target model based on the data relevant to specific information included in the first data to identify the third data generated by the target model based on the content of the first data, the third data being the data corresponding to the specific information.

When it is determined that the content of the interaction data meets the output condition, the third data can be output to the second device. When the third data is output to the second device, the data type presented by the third data may be related to the type of the current conversation.

Specifically, if the current conversation between the first device and the second device is a voice call, the third data can be converted into an audio data type, and the third data in the audio data type can be output to the second device. After the second device obtains the third data of the audio data type, the third data can be played back on the second device, thereby enabling the user of the second device to hear the playback of the third data.

To ensure that the user of the second device does not feel abrupt when hearing the playback of the third data, a target timbre and/or target emotion may be set when converting the third data into the audio data type. That is, the third data can be converted into audio of an audio data type with the target timbre and/or target emotion. In this way, the user of the second device can hear the third data with the target timbre and/or the target emotion, thereby ensuring the communication experience of the user of the second device during voice communication with the first device.

In some embodiments, the target timbre may be a preset timbre, or an emulated timbre derived by simulating the timbre of the user of the first device. The target emotion may be a pre-set emotion, or it may be an emotion derived by determining and simulating the current emotional state of the user of the first device.

Consistent with the present disclosure, the interaction data is obtained based on the conversation with the second device. The interaction data includes first data transmitted from the second device to the first device, and the second data being obtained via an input component of the first device. The interaction data is then analyzed. In response to the interaction data meeting an output condition, the third data is output to the second device, the third data being data generated by the target model based on the content of the first data. In this way, when the first device and the second device engage in a conversation, the content of the interaction data exchanged during the conversation can be analyzed. Subsequently, when a specific condition is met, data generated by a target model based on the content of first data can be output. This realizes the generation and output of third data based solely on interaction data, thereby simplifying the operational workflow for outputting the third data during conversational exchanges, enhancing the efficiency of conversational communication, and improving the user experience.

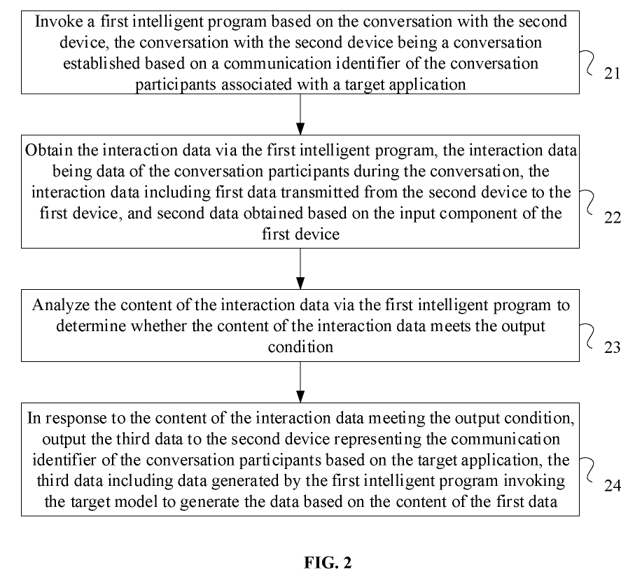

FIG. 2 is a flowchart of the information processing method according to some embodiments of the present disclosure. The method will be described in detail below.

21, invoking a first intelligent program based on the conversation with the second device, the conversation with the second device being a conversation established based on a communication identifier of the conversation participants associated with a target application.

22, obtaining the interaction data via the first intelligent program, the interaction data being data of the conversation participants during the conversation, the interaction data including first data transmitted from the second device to the first device, and second data being obtained based on the input component of the first device.

23, analyzing the content of the interaction data via the first intelligent program to determine whether the content of the interaction data meets the output condition.

24, in response to the content of the interaction data meeting the output condition, outputting the third data to the second device representing the communication identifier of the conversation participants based on the target application, the third data including data generated by the first intelligent program invoking the target model to generate the data based on the content of the first data.

The information processing method provided in this embodiment can be applied to a first device. The first device may be used to monitor the conversation between the first device and the second device. When it is determined that a conversation has been established between the first device and the second device, a first intelligent program may be invoked to monitor the content of the interaction data exchanged during the conversation. When the output condition is met, that is, when there is a need to output the relevant data, the third data can be promptly transmitted to the second device, thereby ensuring the communication efficiency between the first device and the second device.

In some embodiments, the conversation between the first device and the second device may be a conversation established based on the communication identifier of the parties in the target application, which can be a calling application. For example, the conversation may be a call established between two devices using a phone number from the mobile phone’s contact list. In some embodiments, the target application may also be a voice application. For example, the conversation may be a voice call between the first device and user A’ second device using user A's identifier within a voice application. In some embodiments, the target application may also be a text messaging application. For example, the conversation may be a conversation between the first device and the second device via short message service (SMS) or via WeChat messages.

When the first device and the second device establish a conversation via the communication identifiers of the target application's session participants, the data output from the first device to the second device and the data output from the second device to the first device during the course of the conversation may both be identified as interaction data.

The first device can monitor whether it has established a conversation with other devices. When it is determined that the first device has established a conversation with other devices, the first intelligent program may be invoked to perform monitoring and/or supplementation during the subsequent communication process.

If the first device sends a short message to a specific communication identifier, it can be determined that a conversation has been established between the first device and the second device corresponding to that communication identifier. At this time, the first intelligent program can be invoked to monitor and analyze the interaction data exchanged between the first device and the second device. Alternatively, if the first device receives a short message sent by the second device, it can be determined that a conversation has been established between the first device and the second device. At this time, the first intelligent program can be invoked.

If the first device sends a voice communication request to a specific communication identifier, or if the first device receives a voice communication request sent by a second device, it can be determined that a conversation has been established between the first device and the second device corresponding to the communication identifier. At this time, the first intelligent program can be directly invoked. Alternatively, the first intelligent program may be invoked only after the first device sends a voice communication request to a specific communication identifier, it is determined that the request has been responded to, and the first device is able to establish voice communication with the second device corresponding to the communication identifier. This ensures that when the first intelligent program is invoked, interaction data is available for analysis.

It should be noted that, upon the first device determining that a conversation \ has been established between the first device and a second device, the first intelligent program may be invoked by the first device, thereby enabling the first intelligent program to promptly launch and perform an analysis of interaction data following the establishment of the conversation. Alternatively, the first intelligent program may be used to monitor whether the first device has established a conversation with other devices. If it is determined that the first device has established a conversation with other devices, the first intelligent program can be actively launched to enable the first intelligent device to analyze the content of the interaction data exchanged during the conversation. Conversely, if it is determined that the first device has not established a conversation with other devices, the first intelligent program will not be launched or invoked.

After being invoked, the first intelligent program analyzes the content of the interaction data exchanged during the conversation to determine whether it meets the output condition. When the output condition is met, the first intelligent program instructs the target application to output the third data to the second device representing the counterparty's communication identifier. That is, after the first intelligent program determines that the content of the interaction data meets the output condition, it invokes the target model and causes the target model to generate the third data based on the content of the first data. After the target model generates the third data, the first intelligent program can control the target model to directly transmit the third data to the target application, and output the third data to the second device representing the counterparty's communication identifier via the target application. Alternatively, after the target model generates the third data, the first intelligent program can obtain the third data from the target model and output the third data via the target application to the second device representing the counterparty's communication identifier.

Consistent with the present disclosure, when it is determined that the first device and the second device have established a conversation via a target application, the first device can invoke a first intelligent program to analyze the content of the interaction data exchanged during the conversation. When it is determined that the content of the interaction data meets the output condition, the third data generated by the target model based on the content of first data can be output to the second device. In this way, when a conversation is established, the first intelligent program can be invoked to monitor the interaction data exchanged during the conversation. When there is a need to output data, the third data can be generated and output to ensure the smooth progression of the conversation, thereby preventing any information from failing to be transmitted, ensuring communication efficiency, and enhancing the user experience.

In some embodiments, the conditions for determining that the content of the interaction data meets the output condition may include: determining that the content of the interaction data meets the output condition when the first data includes a first keyword; determining that the content of the interaction data meets the output condition when the second data include a second keyword; and determining that the content of the interaction data meets the output condition when the second data does not include a third keyword corresponding to the first keyword in the first data.

After determining that a conversation has been established between the first device and the second device, the content of the interaction data can be analyzed. When it is determined that the content of the interaction data meets any one of the conditions described above, it can be determined that the content of the interaction data meets the output condition. At this time, the third data can be output to the second device to allow the second device to obtain the third data and ensure that the user of the second device can obtain complete information.

In some embodiments, if, based on the first data within the interaction data, it is determined that the output condition is met, whether the first data includes the first keyword may be determined. When it is determined that the first data includes the first keyword, it is determined that the output condition is met.

The first data may be of data transmitted from the second device to the first device, that is data output by the user of the second device. When the user of the second device wants to obtain specific information, the user expresses this within the data transmitted to the first device. Therefore, if the first data transmitted from the second device to the first device includes the first keyword, it can be determined that the output condition is met. At this time, the third data can be transmitted to the second device such that the user of the second device can obtain the corresponding information.

In some embodiments, a plurality of first keyword may be pre-stored. When analyzing the interaction data, if it is determined that a specific first keyword is present within the first data of the interaction data, it can be determined that the output condition is met. In other embodiments, the first keyword may not be stored. When analyzing the interaction data, if the semantics of the second data within the interaction data indicate that specific information currently requires querying and output, the output condition can be determined to be met.

For example, user 1 is using a first device, user 2 is using a second device, and user 1 and user 2 are engaged in a voice call. At this time, a conversation is established between the first device and the second device. If user 2 uses the second device and asks: "Do you have [Name]'s phone number?", this statement constitutes the first data. At this time, the system or the first intelligent program corresponding to the information processing method provided in this embodiment can determine that the first data includes the keyword "phone number." If this keyword is a pre-stored keyword, then it is determined that the output condition is met. Alternatively, the system or the first intelligent program can analyze the first data. If it determines that a query for "[Name]’s phone number" is currently required, it designates "[Name]’s phone number" as the first keyword and determines that the output condition is met.

In another example, if user 2 says “Tell me your package tracking number” via the second device, this phrase may be determined as the first data. At this time, the system or the first intelligent program can determine that the first data summary includes the keyword "package tracking number." If this keyword is pre-stored in the device, then it is determined that the output condition is met. Alternatively, the system or the first intelligent program can analyze the first data. If it determines that a package tracking number currently needs to be queried, the system or the first intelligent program can designate "package tracking number" as the first keyword and determine that the output condition is met.

In addition, when the first data includes the first keyword, the output condition can be determined as met. At this time, the third data need to be output. The third data may be determined based on the first data. In this case, a semantic analysis of the first data, or the data preceding the first data within the current conversation may be performed to determine how the third data was established. Specifically, based on the results of semantic analysis, it can be determined that third data should be queried from a specific application; or the third data should be queried from a specific location on the first device; or the data relevant to the semantic analysis results should be queried from the network to serve as the third data.

It should be noted that when determining that the output condition is met when the first keyword appears in the first data, there is a need to ensure that when the presence of the first keyword in the first data is confirmed, the third data is output within the same conversation. The same conversation means a question-and-answer exchange. That is, the second device outputs the first data. Within the same conversation, the first device responds to the first data and outputs the third data. This ensures the timeliness of the output third data, thereby preventing situations where the first device outputs the third data after a significant delay, leaving the user of the second device uncertain as to what the third data corresponds.

In addition, if, based on the second data within the interaction data, it is determined that the output condition is met, whether the second data include the second keyword may be determined. When it is determined that the second data include the second keyword, it is determined that the output condition is met.

The second data may be obtained based on the input component of the first device. That is, the user of the first device outputs the second data for transmission to the second device such that the user of the second device can receive the second data. The information processing method provided in this embodiment is applied to the first device. When the user of the first device outputs the second data, the input component of the first device is capable of obtaining the second data. If the purpose of the second data is to enable the user of the second device to obtain specific information, the second data must include a second keyword, the second keyword representing the information that the user of the second device needs to obtain. After receiving the second data, the first device can analyze data to determine if it includes the second keyword to establish that the user of the second device needs specific information. If the second keyword is included in the second data, it can be determined that the output condition is met. In this case, after transmitting the second data to the second device, the third data also need to be transmitted to the second device, the third data being information required by the user of the second device.

In some embodiments, a plurality of second keywords may be pre-stored. When analyzing the interaction data, if it is determined that a specific second keyword is present within the second data of the interaction data, it can be determined that the output condition is met. In other embodiments, the second keyword may not be stored. When analyzing the interaction data, if the semantics of the second data within the interaction data indicate that specific information currently requires querying and output, the output condition can be determined to be met.

For example, user 1 is using a first device, user 2 is using a second device, and user 1 and user 2 are engaged in a voice call. At this time, a conversation is established between the first device and the second device. If user 1 says: "Please provide the package tracking number”, this statement constitutes the second data. At this time, the system or the first intelligent program determines that the second data include the keyword “package tracking number”. If this keyword is one of the pre-stored keywords, then it is determined that the output condition is met. Alternatively, the system or the first intelligent program can analyze the second data. If it is determined that there is a need to search for the package tracking number, then the system or the first intelligent program can designate "package tracking number" as the second keyword and determine that the output condition is met.

In another example, user 1 is using a first device, user 2 is using a second device, and user 1 and user 2 are engaged in a voice call. At this time, a conversation is established between the first device and the second device. If user 1 says: "Wait a moment, let me check.", this statement constitutes the second data. At this time, the system or the first intelligent program determines that the second data include the keyword “let me check”. If this keyword is one of the pre-stored keywords, then it is determined that the output condition is met. Alternatively, the system or the first intelligent program can analyze the second data. If it is determined that there is a need to search for the package tracking number, then the system or the first intelligent program can designate "let me check" as the second keyword and determine that the output condition is met.

In addition, when the second data include the second keyword, the output condition can be determined as met. At this time, the third data need to be output. The third data may be determined based on the second data, and the first data may be data transmitted from the second device to the first device prior to the second data, the data including the second keyword. In this case, a semantic analysis of the first data, or multiple pieces of first data preceding the second data within the current conversation may be performed to determine how the third data was established. Specifically, based on the results of semantic analysis, it can be determined that third data should be queried from a specific application; or the third data should be queried from a specific location on the first device; or the data relevant to the semantic analysis results should be queried from the network to serve as the third data.

In some embodiments, when determining that the output condition is met when the second keyword appears in the second data, there is a need to ensure that when the presence of the second keyword in the second data is confirmed, the third data is output within the same conversation. The same conversation means a question-and-answer exchange. That is, the user of the first device outputs the second data. While the first device transmits the second data to the second device, the first device determines that the output condition is met and, in response to the second data, outputs the third data. That is, after the first device outputs the second data, within the same conversation, the first device outputs the third data to ensure the timeliness of the output of the third data.

In some embodiments, the conditions of determining that the output condition is met based on the second data within the interaction data may also include: determining whether the second data include a third keyword corresponding to the first keyword in the first data. If it is determined that the second data do not include the third keyword corresponding to the first keyword in the first data, determine that the output condition is met.

During the conversation between the first device and the second device, if the first data within the interaction data of a specific round of conversation includes the first keyword, it may indicate that the user of the second device needs certain information from the user of the first device or from the first device itself. However, in the subsequent rounds of conversation, if the third keyword corresponding to the first keyword of the first data did not appear in the second data of the interaction data, it may indicate that the user of the first device did not respond to the first data including the first keyword in the subsequent rounds of conversation. At this time, to ensure that the user of the second device can timely obtain the information needed, relevant information may be provided by a system or an intelligent program by generating the third data via a target model and outputting the third data to the second device. Therefore, if it is determined that the second data do not include a third keyword corresponding to the first keyword of the first data, the output condition can be determined as met.

In some embodiments, the system or intelligent program may analyze the interaction data during the conversation but may not actively output data. That is, upon detecting the presence of the first keyword within first data, the system or intelligent program may not directly output the third data in response to the first data; instead, it waits for the user of the first device to determine whether the user of the first device outputs the second data in response to the first data. If the user of the first device outputs second data in response to the first data, then the system or intelligent program does not need to output the third data. If it is determined that the user of the first device has consistently failed to output the second data in response to the first data, that is, the second data does not include the third keyword corresponding to the first keyword within the first data, at this time, the system or intelligent program can output the third data in response to the first data, thereby ensuring that the user of the second device receives the relevant information in a timely manner.

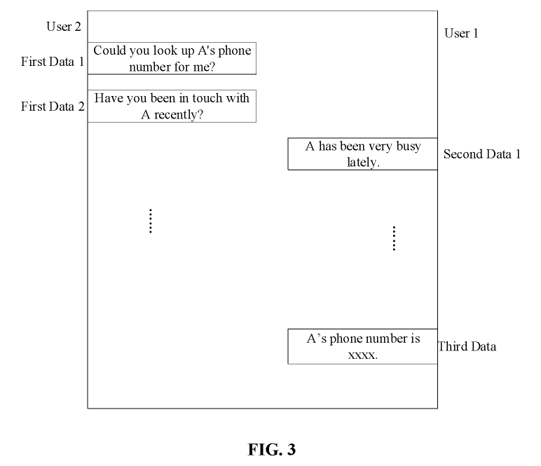

For example, user 1 is using a first device, user 2 is using a second device, and user 1 and user 2 are engaged in a conversation via short messages. FIG. 3 is a schematic diagram of a communication interface on a first device when a first user and a second user are engaged in a conversation via text messages according to some embodiments of the present disclosure. As shown in FIG. 3, the text content on the left side of the communication interface consists of multiple pieces of first data transmitted by user 2 from the second device to the first device; the text content on the right side of the communication interface consists of multiple pieces of second data output by user 1 and acquired by the input component of the first device, the multiple pieces of second data being transmitted to the second device. User 2 outputs a certain piece of first data, e.g., first data 1: "Could you look up A's phone number for me?" Subsequently, user 2 proceeds to output additional "first data", e.g., first data 2: "Have you been in touch with A recently?", resulting in user 1 responding solely to first data 2, while failing to respond to first data 1. Or, after receiving the first data 1, user 1 did not respond to it; instead, user 1 outputs other pieces of second data, e.g., second data 1: “A has been very busy lately". Consequently, user 2 did not receive the phone number for A that user 1 was supposed to provide in response to first data 1. At this time, the system or intelligent program detects this situation, queries the first device to retrieve A’s phone number based on the first data 1, generates third data, and outputs the third data to the second device. For example, the third data may be: “A’s phone number is xxxx”. This ensures that if user 1 fails to respond to the first data point in a timely manner, user 2 can promptly obtain A's phone number.

In some embodiments, since the current output condition is met by the absence of the third keyword corresponding to the first keyword associated with the first data within the second data of the interaction data across multiple rounds of exchanges, the multiple rounds of exchanges may be defined as a series of exchanges within a single topic. The topic may be the topic of the exchanges in which the first data is situated, the first data being data including the first keyword.

Specifically, if the second data do not include a third keyword corresponding to the first keyword of the first data, and the interaction data indicates a topic is ended, then it may indicate that the output condition is met.

In some embodiments, during a conversation between the first device and the second device, multiple rounds of exchanges may occur, and different exchanges may correspond to the same topic or different topics. A topic may include multiple rounds of exchanges or include a single round of exchange. Based on interaction data, whether a topic has ended or if a new topic has begun can be determined.

When it is determined that the first data includes the first keyword, and that none of the second data within multiple rounds of exchanges includes the third keyword corresponding to the first keyword of the first data, that is, in the multiple rounds of exchanges, the user of the first device did not respond to the first data including the first keyword. At this time, the interaction data can continue to be analyzed. If, based on interaction data, it is determined that the topic corresponding to the first data including the first keyword has concluded, this may indicate that the user of the first device and the user of the second device are about to begin a new topic, or have already begun a new topic. At this time, it can be determined that the output condition is met, that is, the system or intelligent program can now respond to the first data including the first keyword.

To ensure that no information is omitted from the concluded topic, there is a need to respond to the first data including the first keyword that the user of the first device failed to address. At this time, the target model may generate a response to the first data including the first keyword, that is, generating the third data, and output the third data to the second device. In this way, the user of the second device can receive the response to the first data including the first keyword.

For example, the first data including the first keyword may be: “Please help me look up B’s package tracking number”. After multiple rounds of exchanges, no response was received regarding the first data. Then, upon the conclusion of the topic corresponding to the multiple rounds of exchanges, third data corresponding to the first data may be generated and output to the second device. For example, the third data may be: “The package tracking number for B that you requested is xxxxx”. Alternatively, the third data may be: “I’m Lenovo AI Now. Just to add, the package tracking number for B that you requested is xxxxx”. That is, the supplementary third data may indicate that the current output third data was generated and output by a system or an intelligent program, or it may not indicate that it was generated and output by a system or an intelligent program.

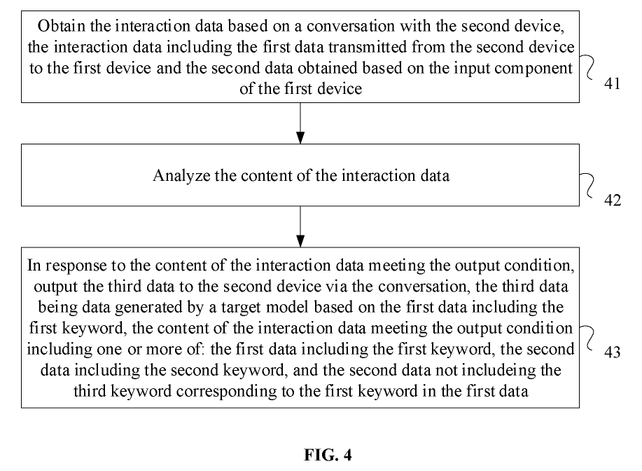

FIG. 4 is a flowchart of the information processing method according to some embodiments of the present disclosure. The method will be described in detail below.

41, obtaining the interaction data based on a conversation with the second device, the interaction data including the first data transmitted from the second device to the first device and the second data being obtained based on the input component of the first device.

42, analyzing the content of the interaction data.

43, in response to the content of the interaction data meeting the output condition, outputting the third data to the second device via the conversation, the third data being data generated by a target model based on the first data including the first keyword. The content of the interaction data meeting the output condition may include one or more of: the first data including the first keyword, the second data including the second keyword, and the second data does not include the third keyword corresponding to the first keyword in the first data.

During the communication between the first device and the second device, a system or intelligent program may analyze the interaction data of the conversation to determine whether the output condition is met. When the output condition is met, the third data can be generated and output.

In some embodiments, the third data may be generated by a target model. That is, where there is a need to transmit the third data that is distinct from the second data output by the user of the first device to the second device, the generation of the third data may be carried out by the target model.

The third data transmitted from the first device to the second device is generally intended to convey information that the user of the second device wishes to know; this information is determined based on the first data transmitted from the second device to the first device. If the first data includes the first keyword, it can be determined that the user of the second device wishes to obtain information related to the first keyword. Therefore, when the system or intelligent program determines that the output condition is met, it may transmit the first data including the first keyword to the target model. The target model then queries relevant information based on the first data including the first keyword, to generate the third data. After generating the third data, the system or intelligent program transmits the third data to the second device, thereby enabling the user of the second device to access the information associated with the first keyword, that is, the third data.

In some embodiments, the target model may perform a query based on the input first data and the first keyword included in the first data, and designate the retrieved information as the third data. Alternatively, after the target model performs querying based on the first data and the first keyword, and obtains the retrieved information, the retrieved information may be analyzed and organized to derive the third data.

In some embodiments, after inputting the first data and the first keyword included in the first data into the target model, the target model may perform semantic analysis on the first data to obtain a semantic analysis result. The first keyword can be combined with the semantic analysis result to jointly determine the specific information required for the query, thereby enabling the retrieval of relevant information. Alternatively, while inputting the first data and the first keyword included in the first data into the target model, the interaction data preceding the first data including the first keyword may also be sent to the target model. This enables the target model to precisely analyze the specific information currently being queried, thereby ensuring the accuracy of the generated third data.

It should be noted that, in order to protect user privacy, in the embodiments of the present disclosure, both the first device and the second device are authenticated devices. Therefore, during the communication between the first device and the second device, the target model can query various information from the first device, and can also transmit the third data queried and generated by the target model to the second device, thereby reducing the risk of information leakage in the first device.

In addition, during the communication between the first device and the second device, the content of the interaction data can be analyzed. When it is determined that the output condition is met, the target model needs to generate and output the third data based on first data including the first keyword. Therefore, when it is determined that the output condition is met, there is a need to evaluate whether the first data including the first keyword raises privacy concerns. If the first data involves privacy concerns, the system will not respond to the output condition being met. That is, even if the output condition is met, the target model will not be controlled to query the first data and generate the third data, nor will it transmit the third data to the second device; thereby effectively mitigating the risk of information leakage within the first device.

Consistent with the present disclosure, the first device obtains the interaction data based on a conversation with a second device. The interaction data includes the first data transmitted from the second device to the first device, and the second data being obtained via an input component of the first device. The content of the interaction data is analyzed to determine whether it meets an output condition. When the output condition is met, the third data is output to the second device via the conversation. The third data is generated by a target model based on the first data including the first keyword. The content of the interaction data meeting the output condition may include one or more of: the first data including the first keyword, the second data including the second keyword, and the second data does not include the third keyword corresponding to the first keyword in the first data. When it is determined that the first data includes the first keyword, the target model, in generating the third data, needs to base its generation on the first data including the first keyword to ensure the accuracy of the third data generated by the target model.

In some embodiments, the information processing method may further include: when the third data is output to the second device, if second data belonging to the same round of exchanges as first data is present, transmitting the second data to the second device or not transmitted to the second device based on the conversation.

The interaction data may be obtained during the conversation between the first device and the second device. If it is determined that the output condition is met, a third data may be determined and output to the second device. If the third data is generated based on the first data including the first keyword, then the third data can be output as part of the same round of exchange as the first data including the first keyword. That is, in the Nth round of interaction data, the first data transmitted from the second device to the first device includes the first keyword. If the output condition is met at this time, the generated third data can also be output within the Nth round of interaction data, thereby enabling the user of the second device to obtain the third data during the Nth round of exchange. That is, as long as the first data including the first keyword is obtained from the second device, the first device can directly feed back the third data when it responds to ensure that the first data including the first keyword and the third data are in the same round of exchange.

In addition, since the third data may be generated by the target model based on the content of the first data, and it is only generated and output in response to the first data transmitted by the second device. However, the first data is transmitted from the second device to the first device, and the user of the first device is aware of the first data. Therefore, when the user of the first device receives the first data, the user may have other data to transmit to the second device such that the user of the second device can receive the information that the user of the first device wants to transmit. The information that the user of the first device wants to transmit can be determined as the second data. If the second data is the same as the third data, then when outputting the third data to the second device, there is no need to output the second data again. If the second data is different from the third data, while ensuring that the third data and the first data including the first keyword, are in the same round of exchange, when outputting the third data, since the third data is used in response to the first data, the second data, which is not used in response to the first data, may not need to be output again.

For example, the first data is: “Do you know the package tracking number?” The target model generates a third data based on the first data, and the third data is: “The package tracking number is xxxxx”. When the user of the first device receives the first data, the user input second data through the input component of the first device, the second data being: "What was purchased in this package?" In this case, the third data was generated in response to the first data, while the second data was not generated in response to the first data. To allow the user of the second device to promptly obtain the information needed, the third data can be directly output. The second data may not be transmitted to the second device; that is, the input component of the first device obtains the second data but does not transmit it to the second device.

Alternatively, in the above example, after obtaining the first data, the target model can quickly generate the third data. During the generation and output of the third data, the user of the first device has not yet found the package tracking number he is looking for in the first data. At this time, since the third data has already been output, the user of the first device will no longer output the second data; instead, the third data may be output directly by the system or an intelligent program to provide a response to the first data.

Furthermore, when the user of the first device hears the question of “Do you know the package tracking number?” from the other party, if the use does not know the package tracking number and need to look it up, the user may say, "Ah... I don't know, wait a minute, let me check." In this embodiment, the third data can be generated based on a target model. In this case, instead of sending the response “Ah... I don't know, wait a minute, let me check” to the user of the second device, the third data generated based on the target model may be directly substituted for the response of the user of the first device.

In addition, during the conversation between the first device and the second device, if the first data transmitted from the second device to the first device is obtained and the output condition is met, the target model may generate the third data based on the first data and output the third data to the second device. When the user of the first device learns of the first data, the user may have other data to transmit to the second device such that the user of the second device can receive the information that the user of the first device wishes to transmit, i.e., the second data. When the first device outputs third data to the second device, the first device can also receive the second data input by the user of the first device through the input component of the first device, and the first device can also output the second data to the second device. In this way, the second device can not only receive the third data used in response to the first data, but also the second data output by the user of the first device.

Continuing with the aforementioned example for illustration purposes. The first data is "Do you know the package tracking number," the third data point "The package tracking number is xxxxx," and the second data is "What was purchased in this package?" The first device then outputs third data and second data to the second device such that the user of the second device can not only obtain the tracking number, but also the questions of the user of the first device.

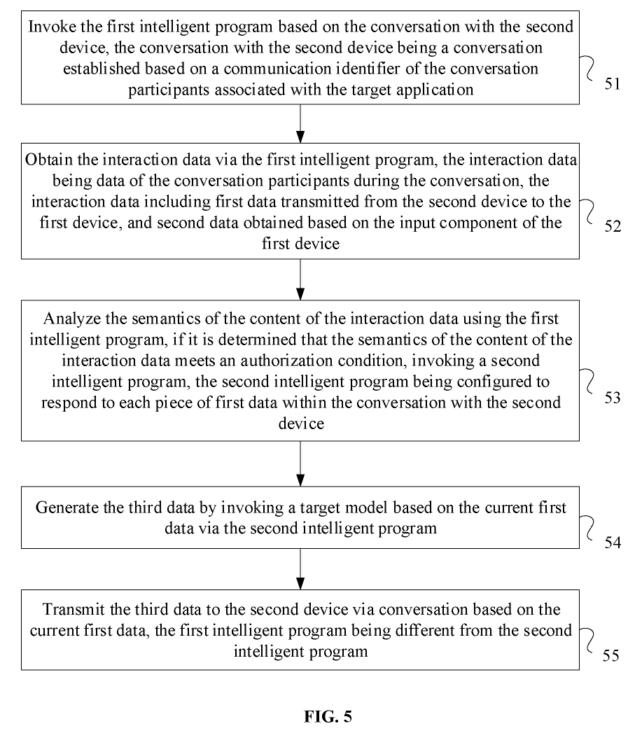

FIG. 5 is a flowchart of the information processing method according to some embodiments of the present disclosure. The method will be described in detail below.

51, invoking the first intelligent program based on the conversation with the second device, the conversation with the second device being a conversation established based on a communication identifier of the conversation participants associated with the target application.

52, obtaining the interaction data via the first intelligent program, the interaction data being data of the conversation participants during the conversation, the interaction data including first data transmitted from the second device to the first device, and second data being obtained based on the input component of the first device.

53, analyzing the semantics of the content of the interaction data using the first intelligent program, if it is determined that the semantics of the content of the interaction data meets an authorization condition, invoking a second intelligent program, the second intelligent program being configured to respond to each piece of first data within the conversation with the second device.

54, generating the third data by invoking a target model based on the current first data via the second intelligent program.

55, transmitting the third data to the second device via conversation based on the current first data, the first intelligent program being different from the second intelligent program.

The first device and the second device can be engaged in a conversation. During the conversation, there will be interaction data, that is, the first data transmitted from the second device to the first device, and the second data being obtained based on the input component of the first device and which needs to be transmitted to the second device. In addition, when the output condition is met, the target model can generate the third data and transmit it to the second device.

When it is determined that a conversation exists between the first device and the second device, an intelligent program can be invoked, which will then perform the operation of whether to generate and output third data. Specifically, in some embodiments, there may be a first intelligent program and a second intelligent program. The first intelligent program and the second intelligent program may have different permissions and may be used to perform different operations to ensure that the information processing method provided in the embodiments of the present disclosure can be completed smoothly, quickly and accurately during execution.

Specifically, when it is determined that there is a conversation between the first device and the second device, the first intelligent program can be invoked first to obtain and analyze the interaction data during the conversation. The first intelligent program can also output the third data generated based on the target model to the second device when it is determined that the content of the interaction data meets the output condition. In this way, the second device can promptly obtain the third data in response to the first data, thereby eliminating the need for manual querying by the user and simplifying the operation process.

In addition, the first intelligent program may also invoke the second intelligent program when it is determined that the semantics of the content of the interaction data meet the authorization condition.

In some embodiments, the authorization condition may include: the first data within the interaction data including a fourth keyword, or the second data within the interaction data including a fifth keyword.

For example, the first data is “Use your AI assistant to analyze this for me.” Since the first data is transmitted from the second device to the first device, the first intelligent program on the first device, after obtaining and analyzing the first data, may directly invoke the second intelligent program, i.e., the AI assistant, on the first device based on the first data.

In another example, the second data is “Go chat with my AI assistant.” Since the second data is input from the user of the first device obtained by the input component of the first device, the first intelligent program of the first device, after obtaining and analyzing the second data, may directly invoke the second intelligent program in the first device, i.e., the AI assistant, based on the second data. In this way, the second intelligent program can respond to each piece of first data in the conversation.

Therefore, the first intelligent program can be invoked when there are conversations between the first device and other devices, and after invocation, it can analyze the interaction data in the conversations. When the output condition is met, the first intelligent program can also output the third data to the second device. Once invoked, the second intelligent program can respond to each piece first data transmitted by the second device during conversation. That is, after the second intelligent program is invoked, its question-and-answer permissions are higher than those of the first intelligent program, which can only output data when the output condition is met. Furthermore, the scope of queries and searches of the second intelligent program is also broader than that of the first intelligent program.

Once invoked, the second intelligent program may respond to each piece of first data in the conversation. That is, as long as the second intelligent program is invoked, during the conversation between the first device and the second device, after obtaining the first data transmitted by the second device, the first device may no longer output the second data to the second device, but may only output the third data generated by the target model through the second intelligent program. At the same time, the first intelligent program may no longer work; instead, the second intelligent program may execute the process of obtaining interaction data, processing the interaction data, and outputting the third data.

After the second intelligent program is invoked, it transmits each piece of first data to the target model. The target model can analyze the first data, or the first data and the interaction data preceding it, to generate the third data. Subsequently, the second intelligent program transmits the third data to the second device via the current conversation. After receiving the first data transmitted from the second device again, the second intelligent program can continue to execute the above process in order to generate the third data and transmit the third data to the second device.

In addition, the first intelligent program may be different from the second intelligent program. For example, the first intelligent program and the second intelligent programs may be different intelligent programs. Alternatively, the first intelligent program and the second intelligent programs may be the same intelligent program, but in different operation modes such that the scope of question-and-answer permissions and the scope of data retrieval are different. In some embodiments, different intelligent programs may be invoked in different scenarios.

Consistent with the present disclosure, when the first device and the second device are engaged in a conversation, the first intelligent program can be invoked. The first intelligent program can retrieve and analyze the interaction data exchanged during the conversation. When the first intelligent program determines that the interaction data meets the authorization condition, the second intelligent program can be invoked. Subsequently, the second intelligent program can generate the corresponding response, thereby ensuring that different intelligent programs are executed in different scenarios and ensuring the operational efficiency of the intelligent programs.

In some embodiments, the information processing method may further include the process of outputting the third data at the first device.

Since the third data may be generated by the target model based on the content of the first data, while outputting the third data to the first device, there is also a need to transmit the third data to the second device to ensure that the third data corresponding to the first data is output to the second device. This ensures that when the user of the second device receives the third data, the user of the first device is also aware of the content of the third data transmitted from the first device to the second device, thereby ensuring that when the third data needs to be supplemented or adjusted, the user of the first device can promptly output supplementary information to the second device. This ensures that the information obtained by the second device is complete and accurate, thereby ensuring the accuracy of the information output to the second device.

In addition, when the first device outputs the third data, if feedback information from the user of the first device is obtained, the feedback information can be analyzed. If it is determined that the feedback information indicates that the user of the first device did not clearly hear the content of the third data output by the first device, the first device may adjust the manner in which it outputs the third data based on the feedback information. For example, instead of outputting the third data as audio, the first device displays the third data as text content. This would avoid situations where the user of the first device is not able to hear the audio of the third data due to cluttered environments. Alternatively, If the first device outputs the third data in the form of audio, and the third data is output in the form of a receiver, then the third data can be output by the first device in the ways of: outputting the third data through the speaker of the first device; or increasing the volume when the first device outputs the third data; or repeatedly outputting the third data in the form of audio through the first device, etc.

Alternatively, if the feedback information from the user of the first device is obtained when the first device outputs third data, the feedback information can be analyzed. If the feedback information indicates that the user of the first device cannot clearly see the content of the third data output by the first device, the first device may adjust the output method of the third data based on the feedback information. For example, the output of the third data from the first device can be changed from text to audio to avoid situations where users of the first device cannot clearly see the audio of the third data due to obstructed vision or other issues. That is, the third data that is displayed in text form by the first device can be broadcast automatically.

In some embodiments, the first device may output third data. In addition, the first device may also output the first data. When the first device outputs third data and/or first data, the data output method of outputting third data and/or first data may be adjusted.

Specifically, target sensing parameters can be obtained, and the output method of the first device outputting the third data and/or the first data can be adjusted based on the target sensing parameters. Alternatively, the attitude of the first device can be determined, and the output method of the first device outputting the third data and/or the first data can be adjusted based on the attitude of the first device.

In some embodiments, when the third data is output locally on the first device, it can be presented in text form such that the user of the first device can receive the accurate text content of the third data. Of course, the third data can also be output in audio format to ensure that the user of the first device receives the information from the third data in a timely manner.

The target sensing parameters can be the distance parameters detected by the distance sensor on the first device, or the distance parameters obtained by analyzing the image information acquired by the image acquisition sensor on the first device. When the distance parameter is below a certain threshold, it may indicate that the distance between the first device and the user of the first device is relatively close. At this time, if the data is presented in text format, the font size within the text can be adjusted; if the data is presented in audio format, the volume of the audio output can be adjusted. If the distance parameters indicate that the distance between the first device and the user of the first device is relatively far, the volume of the output of the third data and/or the first data can be increased. If the distance parameters indicate that the distance between the first device and the user of the first device is relatively close, the volume of the output of the third data and/or the first data can be decreased. Alternatively, the audio adjustment can also be done by using the speaker or the receive to output the audio. If the distance parameters indicate that the first device is relatively close to the target area (e.g., the ear) of the user of the first device, the first device can be adjusted such that it outputs third data and/or first data through the receiver. If the distance parameters indicate that the first device is relatively far from the target area (e.g., the ear) of the user of the first device, the first device can be adjusted such that it outputs third data and/or first data through a speaker. This ensures the output quality of the third data and/or the first data when output locally by the first device, and that the user of the first device is able to clearly hear the data output by the first device.

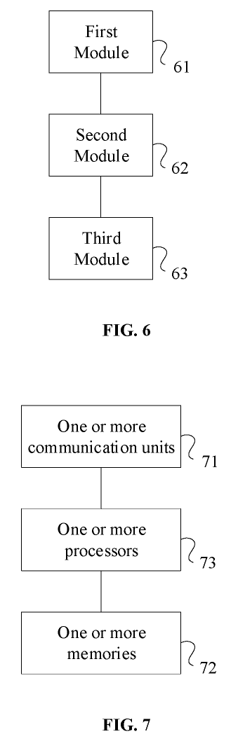

FIG. 6 is a schematic diagram of an information processing device according to some embodiments of the present disclosure. As shown in FIG. 6, the information processing device includes a first module 61, a second module 62, and a third module 63.

In some embodiments, the first module 61 may be configured to obtain the interaction data based on a conversation with the second device, the interaction data including the first data transmitted from the second device to the first device and the second data being obtained based on the input component of the first device.

In some embodiments, the second module 62 may be configured to analyze the content of the interaction data.

In some embodiments, the third module 63 may be configured to, in response to the content of the interaction data meeting an output condition, output third data to a second device, the third data being data generated by a target model based on the content of first data.

In some embodiments, the conversation with the second device may be a conversation established based on the communication identifier of the participants in the target application, and the interaction data may include the participants’ data during the conversation.

In some embodiments, the information processing device may also include a fourth module. The fourth module may be configured to invoke a first intelligent program based on the conversation with the second device. The first intelligent program may be configured to invoke the first module, the second module, and the third module to obtain the interaction data, analyze the content of the interaction data, and, in response to the content of the interaction data meeting the output condition, output the third data to the second device representing the communication identifier of the other participant based on the target application. In addition, the first intelligent program may be further configured to invoke the target model to generate the third data.

In some embodiments, the conditions for determining that the content of the interaction data meets the output condition may include: determining that the content of the interaction data meets the output condition when the first data includes a first keyword; determining that the content of the interaction data meets the output condition when the second data include a second keyword; and determining that the content of the interaction data meets the output condition when the second data does not include a third keyword corresponding to the first keyword in the first data.

In some embodiments, the target model may be configured to generate the third data based on the first data including the first keyword. The third data may be transmitted to the second device based on the conversation.

In some embodiments, the information processing device may also include a fifth module. The fifth module may be configured to, when outputting the third data to the second device, if there are second data belonging to the same round of the exchange as the first data, transmit the second data to the second device or not transmit the second data to the second device based on the conversation.

In some embodiments, if the second data does not include the third keyword that corresponds to the first keyword in the first data, the content of the interaction data meeting the output condition may include: if the second data does not include the third keyword corresponding to the first keyword in the first data, and the interaction data indicating the end of a topic, determining that the content of the interaction data meets the output condition.

In some embodiments, the second module may be configured to analyze the semantics of the content of the interaction data using the first intelligent program, if it is determined that the semantics of the content of the interaction data meets an authorization condition, invoke a second intelligent program, the second intelligent program being configured to respond to each piece of first data within the conversation with the second device

In some embodiments, the third module may be configured to generate the third data by invoking a target model based on the current first data via the second intelligent program, and transmit the third data to the second device via conversation based on the current first data, the first intelligent program being different from the second intelligent program.

In some embodiments, the information processing device may also include a sixth module. The sixth module may be configured to output the third data to the first device.

The information processing device described in this embodiment can be implemented based on the information processing method described in the foregoing embodiments, and details will not be repeated here.

Consistent with the present disclosure, the interaction data is obtained based on the conversation with the second device. The interaction data includes first data transmitted from the second device to the first device, and the second data being obtained via an input component of the first device. The interaction data is then analyzed. In response to the interaction data meeting an output condition, the third data is output to the second device, the third data being data generated by the target model based on the content of the first data. In this way, when the first device and the second device engage in a conversation, the content of the interaction data exchanged during the conversation can be analyzed. Subsequently, when a specific condition is met, data generated by a target model based on the content of first data can be output. This realizes the generation and output of third data based solely on interaction data, thereby simplifying the operational workflow for outputting the third data during conversational exchanges, enhancing the efficiency of conversational communication, and improving the user experience.

FIG. 7 is a schematic structural diagram of an electronic device according to some embodiments of the present disclosure. As shown in FIG. 7, the electronic device includes one or more communication units 71, one or more memories 72, and one or more processors 73.

In some embodiments, the one or more communication units 71 may be configured to carry out a conversation with a second device.

In some embodiments, the one or more memories 72 may be configured to store computer instructions and a target model.

In some embodiments, the one or more processors 73 may be configured to load computer instructions to analyze the content of the interaction data, and output the third data to the second device in response to the content of the interaction data meeting the output condition.

In some embodiments, the processor is also used to load the target model to generate the third data based on the content of the first data.

It should be noted that the electronic device described in this embodiment can be implemented based on the information processing method described in the foregoing embodiments, and details will not be repeated here.

Consistent with the present disclosure, the interaction data is obtained based on the conversation with the second device. The interaction data includes first data transmitted from the second device to the first device, and the second data being obtained via an input component of the first device. The interaction data is then analyzed. In response to the interaction data meeting an output condition, the third data is output to the second device, the third data being data generated by the target model based on the content of the first data. In this way, when the first device and the second device engage in a conversation, the content of the interaction data exchanged during the conversation can be analyzed. Subsequently, when a specific condition is met, data generated by a target model based on the content of first data can be output. This realizes the generation and output of third data based solely on interaction data, thereby simplifying the operational workflow for outputting the third data during conversational exchanges, enhancing the efficiency of conversational communication, and improving the user experience.

In addition, it should be noted that the described apparatus embodiment is merely an example. The units or modules described as separate parts may or may not be physically separate, and parts displayed as units may or may not be physical units, may be located in one position, or may be distributed on a plurality of network units. The units or modules may be implemented by software components, hardware components, or a combination of the software and hardware components. Some or all the modules may be selected based on an actual requirement to achieve the objectives of the solutions of the embodiments. In addition, in the accompanying drawings of the apparatus embodiments provided in this application, connection relationships between modules indicate that the modules have communication connections with each other, which may be specifically implemented as one or more communication buses or signal cables.

Based on the description of the foregoing implementations, a person skilled in the art may clearly understand that this application may be implemented by software in addition to necessary universal hardware, or by dedicated hardware, including a dedicated integrated circuit, a dedicated CPU, a dedicated memory, a dedicated component, and the like. Generally, any functions that can be performed by a computer program can be easily implemented by using corresponding hardware. Moreover, a specific hardware structure used to achieve a same function may be in various forms, for example, in a form of an analog circuit, a digital circuit, or a dedicated circuit. However, as for this application, software program implementation is a better implementation in most cases. Based on such an understanding, the technical solutions of this application essentially or the part contributing to the conventional technology may be implemented in a form of a software product. The computer software product is stored in a readable storage medium, such as a floppy disk, a USB flash drive, a removable hard disk, a ROM, a RAM, a magnetic disk, or an optical disc of a computer, and includes several instructions for instructing a computer device (e.g., a personal computer, a training equipment, a network equipment, etc.) to perform the methods described in embodiments of the present disclosure.

All or some of the foregoing embodiments may be implemented by using software, hardware, firmware, or any combination thereof. When software is used to implement the embodiments, all or a part of the embodiments may be implemented in a form of a computer program product.

The computer program product includes one or more computer instructions. When the computer program instructions are loaded and executed on the computer, the procedures or functions according to embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, communication apparatus, computing device, or data center to another website, computer, communication apparatus, computing device, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a communication apparatus or a data center, integrating one or more usable media. The usable medium may be a magnetic medium (for example, a floppy disk, a hard disk, or a magnetic tape), an optical medium (for example, a DVD), a semiconductor medium (for example, a solid-state disk (SSD)), or the like.

What is claimed is:

1. An information processing method comprising:
obtaining interaction data based on a conversation with a second device, the interaction data including first data transmitted from the second device to a first device, and second data being obtained based on an input component of the first device;
analyzing content of the interaction data; and
in response to the content of the interaction data meeting an output condition, outputting third data to the second device, the third data being data generated by a target model based on content of the first data.

2. The information processing method of claim 1, wherein:
the conversation with the second device is a conversation established based on a communication identifier of conversation participants in a target application, the interaction data being data from the conversation participants during the conversation;
the method further comprising:
invoking a first intelligent program based on the conversation with the second device, the first intelligent program being configured to obtain the interaction data, analyze the content of the interaction data, and, in response to the content of the interaction data meeting the output condition, output the third data to the second device representing the communication identifier of the conversation participants based on the target application, the first intelligent program also being configured to invoke the target model to generate the third data.

3. The information processing method of claim 1, wherein the content of the interaction data meeting the output condition includes one or more of:
determining that the content of the interaction data meets the output condition if the first data includes a first keyword;
determining that the content of the interaction data meets the output condition if the second data include a second keyword; and
determining that the content of the interaction data meets the output condition if the second data does not include a third keyword corresponding to the first keyword in the first data.

4. The information processing method of claim 3 further comprising:
generating the third data based on the first data including the first keyword via the target model; and
transmitting the third data to the second device based on the conversation.

5. The information processing method of claim 4, when outputting the third data to the second device, the method further comprising:
if the second data belong to the same round of exchange as the first data, transmitting the second data to the second device, or not transmitting the second data to the second device, based on the conversation.

6. The information processing method of claim 3, wherein determining that the content of the interaction data meets the output condition if the second data does not include the third keyword corresponding to the first keyword in the first data includes:
determining that the content of the interaction data meets the output condition if the second data does not include the third keyword corresponding to the first keyword in the first data, and the interaction data indicates an end of a topic.

7. The information processing method of claim 2, wherein analyzing the content of the interaction data includes:
analyzing semantics of the content of the interaction data using the first intelligent program, and invoking a second intelligent program if it is determined that the semantics of the content of the interaction data meets an authorization condition, the second intelligent program being configured to respond to each piece of first data within the conversation with the second device; and
in response to the content of the interaction data meeting the output condition, outputting the third data to the second device includes:
invoking the target model to generate the third data based on current first data via the second intelligent program; and
transmitting the third data to the second device based on the current first data via the conversation, the first intelligent program being different from the second intelligent program.

8. The information processing method of claim 1, further comprising:
outputting the third data at the first device.

9. An information processing device comprising:
a first module, the first module being configured to obtain interaction data based on a conversation with a second device, the interaction data including first data transmitted from the second device to a first device, and second data being obtained based on an input component of the first device;
a second module, the second module being configured to analyze content of the interaction data; and
a third module, the third module being configured to, in response to the content of the interaction data meeting an output condition, output third data to the second device, the third data being data generated by a target model based on content of the first data.

10. The information processing device of claim 9, wherein the content of the interaction data meeting the output condition includes one or more of:
determining that the content of the interaction data meets the output condition if the first data includes a first keyword;
determining that the content of the interaction data meets the output condition if the second data include a second keyword; and
determining that the content of the interaction data meets the output condition if the second data does not include a third keyword corresponding to the first keyword in the first data.

11. The information processing device of claim 10, wherein:
the target model is configured to generate the third data based on the first data including the first keyword; and
the third data is transmitted to the second device based on the conversation.

12. The information processing device of claim 10, wherein determining that the content of the interaction data meets the output condition if the second data does not include the third keyword corresponding to the first keyword in the first data includes:
determining that the content of the interaction data meets the output condition if the second data does not include the third keyword corresponding to the first keyword in the first data, and the interaction data indicates an end of a topic.

13. The information processing device of claim 9, wherein the second module is configured to:
analyze semantics of the content of the interaction data using a first intelligent program, and invoke a second intelligent program if it is determined that the semantics of the content of the interaction data meets an authorization condition, the second intelligent program being configured to respond to each piece of first data within the conversation with the second device.

14. The information processing device of claim 9, wherein the third module is configured to:
invoke the target model to generate the third data based on current first data via the second intelligent program; and
transmit the third data to the second device based on the current first data via the conversation, the first intelligent program being different from the second intelligent program.

15. An electronic device comprising:
one of more communication units, the one of more communication units being configured to conduct a conversation with a second device;
one or more memories storing computer instructions and a target model;
one or more processors, the one or more processors being configured to load the computer instructions to analyze content of interaction data, transmit third data to the second device in response to the content of the interaction data meeting an output condition, and load the target model to generate the third data based on content of first data.

16. The electronic device of claim 15, wherein:
the conversation with the second device is a conversation established based on a communication identifier of conversation participants in a target application, the interaction data being data from the conversation participants during the conversation;
the method further comprising:
invoking a first intelligent program based on the conversation with the second device, the first intelligent program being configured to obtain the interaction data, analyze the content of the interaction data, and, in response to the content of the interaction data meeting the output condition, output the third data to the second device representing the communication identifier of the conversation participants based on the target application, the first intelligent program also being configured to invoke the target model to generate the third data.

17. The electronic device of claim 15, wherein the content of the interaction data meeting the output condition includes one or more of:
determining that the content of the interaction data meets the output condition if the first data includes a first keyword;
determining that the content of the interaction data meets the output condition if the second data include a second keyword; and
determining that the content of the interaction data meets the output condition if the second data does not include a third keyword corresponding to the first keyword in the first data.

18. The electronic device of claim 17, the one or more processors being further configured to:
generate the third data based on the first data including the first keyword via the target model; and
transmit the third data to the second device based on the conversation.

19. The electronic device of claim 18, when outputting the third data to the second device, the method further comprising:
if the second data belong to the same round of exchange as the first data, transmitting the second data to the second device, or not transmitting the second data to the second device, based on the conversation.
